(19) United States
(12) Patent Application Publication
(10) Pub. No.: US 2012/0174415 A1
(43) Pub. Date: Jul. 12, 2012

(54) Scissor Handle Opening Sizer

(76) Inventor: Robert T. Sataloff, Philadelphia, PA (US)

(21) Appl. No.: 12/987,107

(22) Filed: Jan. 8, 2011

(51) Int. Cl. B26B 13/20

(52) U.S. Cl. 30/232

(57) ABSTRACT

The present invention has been accomplished to provide cost effective scissor sizer devices that can be used to adjust the size of finger openings on scissors. The sizer may be of a pre-determined size or may be malleable so as to conform to the shape of the scissor handle opening to provide a more secure fit of the sizer with the handle. The sizer may be smooth on its inner surface or may have rough areas on its inner surface in order to help prevent the fingers of the user from slipping within the handle openings.

The sizer may be secured to the scissor handle openings by various means. Means of attachment include use of bendable tabs capable of being bent to grasp and fit to the handle opening. The sizer may also be attached using screws to secure the sizer to the handle opening. The sizer may also contain a ratchet mechanism to secure the sizer to the handle. Further, the sizer may be permanently affixed, by glue or some other means of permanent attachment, to the handle opening.

### BACKGROUND OF THE INVENTION

1. Field of the Invention

Scissors and the like are cutting instruments which consist of oppositely opposed blades connected at a point along each blade by a pivot screw. Scissors are used widely in a variety of professions and environments including schools, offices, the food industry, and the medical profession as examples. A handle or other means of engaging the scissors is usually located at the opposite end of each blade, and cutting action is achieved by squeezing the handles toward each other which, in turn, causes the blades to rotate around the pivot screw toward each other. The blades are positioned so that the blades remain in contact with each other along their entire length as the blades move toward each other. Objects which are positioned between the blades are severed as the blades move together.

In the medical profession, in particular, scissors are used during surgery as a cutting tool during an operation and are also used to sever various medically related items such as threads or “stitches” used to close a wound. Accordingly, it is important that the individual handling the scissors be afforded the greatest comfort and the greatest control of the scissors during use.

Scissors are generally constructed entirely of metal or some other hard material. In some instances, scissor handles may be constructed of plastic. In almost all instances, though, scissor handles are constructed of a rigid material which is not capable of adjustment. Handles are usually constructed of a round or oval shaped opening permitting individuals using the scissors to insert one or more fingers, including a thumb, into the openings to grasp the scissors and move the blades. While the size of the handles is rigid and fixed, the fingers and thumbs of individuals using the scissors vary according to the individual. Accordingly, larger fingers may fit more securely into the handle openings than smaller fingers, and because scissor handles are generally of rigid construction, certain individuals may experience increased discomfort due to an improper fit of the scissor handles to their fingers. Further, individuals with smaller fingers may be unable to firmly grasp the handles resulting in decreased control of the scissors and inaccurate cutting.

Accordingly, it is advantageous to be able to vary the size of the handle opening of scissors in order to accommodate the varying sized fingers of different individuals. The subject invention relates to the structure of a sizer that can be applied inside the handle openings of a pair of scissors or similar instrument and is used to alter the size of the scissor (or similar instrument) handle openings, in order to optimize hand ergonomics. In this document, the term “scissors” shall be construed to mean scissors, or any instrument with a similar handle design such as a hemostat, surgical alligator forceps, needle holder, shears, etc. The scissor sizer will be available in various sizes to accommodate scissors of different sizes and shapes.

2. Description of the Prior Art

Conventional scissors include two scissor blades, a pivot for connecting the scissor blades to each other in an articulated manner, and two scissor blade handles connected to corresponding scissor blades. Each of the scissor blades acts as a first-class lever. Sharpened edges of the scissor blades form two wedges that cut with force into a material from opposite directions. As they meet, they part the material sideways. Scissors are designed with round or ovoid finger openings of fixed size.

Other instruments utilize a similar mechanism of operation. For instance, alligator forceps are instruments in the medical field with a grasping mechanism resembling an alligator's jaws that are used to grasp and hold tissue or other items. Alligator forceps are constructed of a pair of rigid structures connected to each other at a pivot point usually by a screw passed through the structures. A hemostat is an instrument used as a clamp on tissue to control bleeding during surgery. By squeezing handles at one end of each structure together, the opposing ends of the structures move together to grasp and hold objects in between. In a similar manner, the handles are of a fixed size and may not be fitted to the fingers of multiple users. In particular, people with small hands (including many females) who need to use scissors or similar instruments repeatedly and in a precise fashion (e.g. surgeons, seamstresses and others), require finger contact on all sides of each scissor opening for greater control and comfort, and awkward and often uncomfortable hand positions are required to compensate for suboptimal size of the finger openings.

Inventions of the prior art have attempted to address these problems. U.S. Pat. No. 6,212,780 describes an instrument which allows the user to adjust the size of the finger openings of scissor handles. However, use of such a device is awkward and requires extensive manipulation to adjust the opening of the handle openings. Further, constructing the handle openings with a built in adjustment mechanism requires additional labor and machinery and increases the cost of the scissors with the addition of materials for the handle adjustment mechanism. Accordingly, the creation of scissors with adjustable handle openings is cost prohibitive.

Inventions of the prior art have also included various inserts to be fitted within handle openings. Some such inserts have taken the form of complete rings inserted within the handle openings. However, such inserts are limited in that they may only adjust the size of the opening by a fixed dimension and may not be varied to adjust the opening size to fit the differing sized fingers of individual users. Other inserts have taken the form of partial rings. However, such inserts have presented limited means of attachment into the handle opening with the result that the insert is not securely fixed within the handle opening. Accordingly, users of the scissors continue to experience limited control over the scissors while cutting. Some inserts have presented a cushioned material into the handle opening. However, cushioning is not a solid surface, and accordingly, the inserts to not permit users to grasp the handles as firmly and securely resulting in loss of control of the scissors.

Additionally, scissor handle inserts of the prior art have generally been constructed of a non-malleable rigid material. Handle inserts constructed of a non-malleable rigid material are unable to conform to the shape of the scissor handle openings into which they are inserted. Accordingly, such inserts do not fit securely into the handle openings and result in loss of control of the scissors by the user.

Therefore, it is an object of the present invention to provide a device that can be attached to scissors and used to adjust the size of the finger openings so that they will be comfortable and ergonomically efficient for users with hands smaller than those for which standard scissors are designed. It is a further object of the invention to provide a device which contains a non-slip surface such that one using the device with scissors will be able to securely grasp the scissor handles. It is a further object of the present invention to provide a quick and efficient means of adjustment of the size of scissor handle openings that is economic and not cost prohibitive. It is a further object of the present invention to provide a device which is securely seated and fixable to scissor handle openings, yet removable, to prevent slippage of device and loss of control during use. Finally, it is an object of the present invention to provide a device which is malleable to scissor handle openings to provide a secure fit of the device to the scissor handles.

### SUMMARY OF THE INVENTION

The present invention has been accomplished to provide cost effective scissor sizer devices that can be used to adjust the size of finger openings on scissors made by numerous manufacturers, and generally that are available in the market place. Preferably, the scissor sizers are capable of attaching to and fitting any scissor handle openings. In a preferred embodiment of the present invention, a sizer may be inserted inside the finger holes on the handle of scissors or similar instrument. The sizer may be incorporated into pre-manufactured scissors already on the market or may be incorporated into scissors during manufacture.

The sizer may be of a pre-determined size so as to reduce the size of the opening of scissor handles when the sizer is installed. However, the sizer may be malleable so as to conform to the shape of the scissor handle opening to provide a more secure fit of the sizer with the handle. Various sizes of the sizer further may ensure that the sizers may fit into any size scissor handle opening, for example, from shears to small surgical instruments.

The sizer may be smooth on its inner surface or may have rough areas on its inner surface in order to help prevent the fingers of the user from slipping within the handle openings. Use of a roughened surface on the inner surface of the sizer against the fingers of a user will assist in the preventing the scissors from slipping from the hands of the user.

The sizer may be secured to the scissor handle openings by various means. For instance, the sizer may contain bendable tabs which are capable of being bent to grasp and fit to the handle opening. In another embodiment, the screws may be used to secure the sizer to the handle opening. In another embodiment, the sizer may contain a ratchet mechanism to secure the sizer to the handle. Further, if scissors are to be utilized primarily by a single individual, the sizer may be permanently affixed, by glue or some other means of permanent attachment, to the handle opening. Other means of attachment may be used to secure the sizer to the scissor handle opening.

Scissor sizers may be constructed of inexpensive materials so as to permit the user to cost effectively adjust the size of scissor handle openings. However, the sizers may be constructed of stronger materials at a higher cost, such as stainless steel, depending on the needs and preferences of the user.

### BRIEF DESCRIPTION OF THE DRAWINGS

FIG. 1 shows a perspective view of scissors with scissor sizers inserted into the handle openings in use by an individual with fingers inserted in the handle openings.

FIG. 2 shows a top elevational view of scissors with scissor sizers inserted into the handle openings and secured to the handle openings with bendable tabs.

FIG. 3A shows a perspective view of a ring.

FIG. 3B shows a perspective view of a ring and a scissor sizer inserted into the ring.

FIG. 3C shows a perspective view of scissor sizers in various configurations bendable to fit into any size ring or handle opening.

FIG. 4 shows a top elevational view of scissors with scissor sizers inserted into the handle openings and secured to the handle openings by screws.

FIG. 5A shows a top elevational view of scissors with scissor sizers inserted into the handles openings and secured to the handle openings using a ratchet mechanism.

FIG. 5B shows a perspective view of a scissor sizer utilizing a ratchet mechanism as a means of attachment.

### DETAILED DESCRIPTION OF THE INVENTION

The invention relates to providing a scissor sizer device to adjust the size of finger openings on scissors. Scissors, and similar devices, are generally constructed of two elongated structures attached at a central pivot point. As used herein, the term scissors shall be used to include similar instruments such as hemostats, surgical alligator forceps, needle holders, shears, etc. In the case of scissors, the elongated structures are opposing blades 110. A handle 130 or other means of engaging the scissors is usually located at the opposite end of each blade. Each blade is generally of flat construction with a sharpened side 115 running along its length and a blunt opposite side 117. The blades are positioned with the sharpened sides 115 of each blade facing each other. Cutting action is achieved by squeezing the handles 130 toward each other which, in turn, causes the blades to rotate around a pivot screw 120 toward each other. The blades are positioned so that the blades remain in contact with each other along their entire length as the blades move toward each other. Objects which are positioned between the blades are severed as the blades move together.

Scissors are generally constructed entirely of metal or some other non-flexible material. Scissor handles 130 are usually constructed of a round or oval shaped opening permitting individuals using the scissors to insert one or more fingers, including a thumb, into the openings to grasp the scissors and move the blades. Handles are usually of a fixed size and are not adjustable. However, numerous individuals may use the scissors, and the fingers and thumbs of individuals using the scissors will vary according to the individual. The invention relates to scissor sizers 100 which may be fitted into the scissor handle openings in order to reduce the size of the opening for individuals with smaller fingers. Reduction of the scissor handle opening raises the level of comfort for individuals with smaller fingers and permits the individual to more firmly grasp the scissors allowing for greater control during cutting operation.

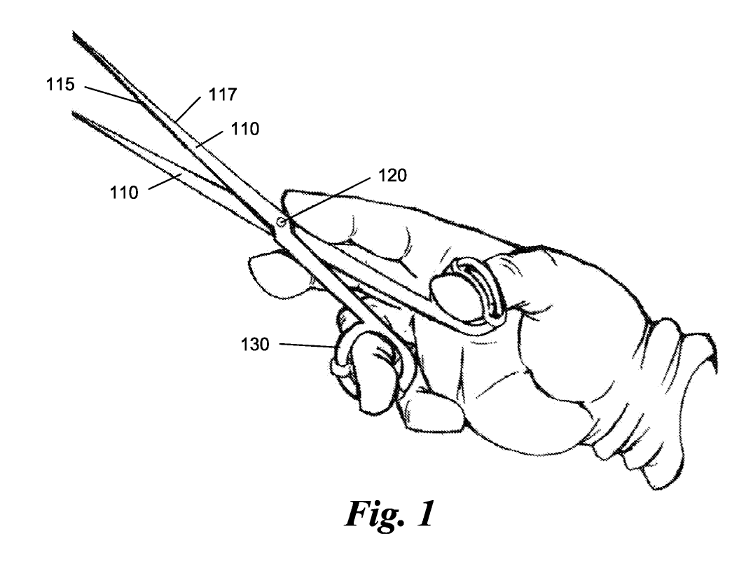

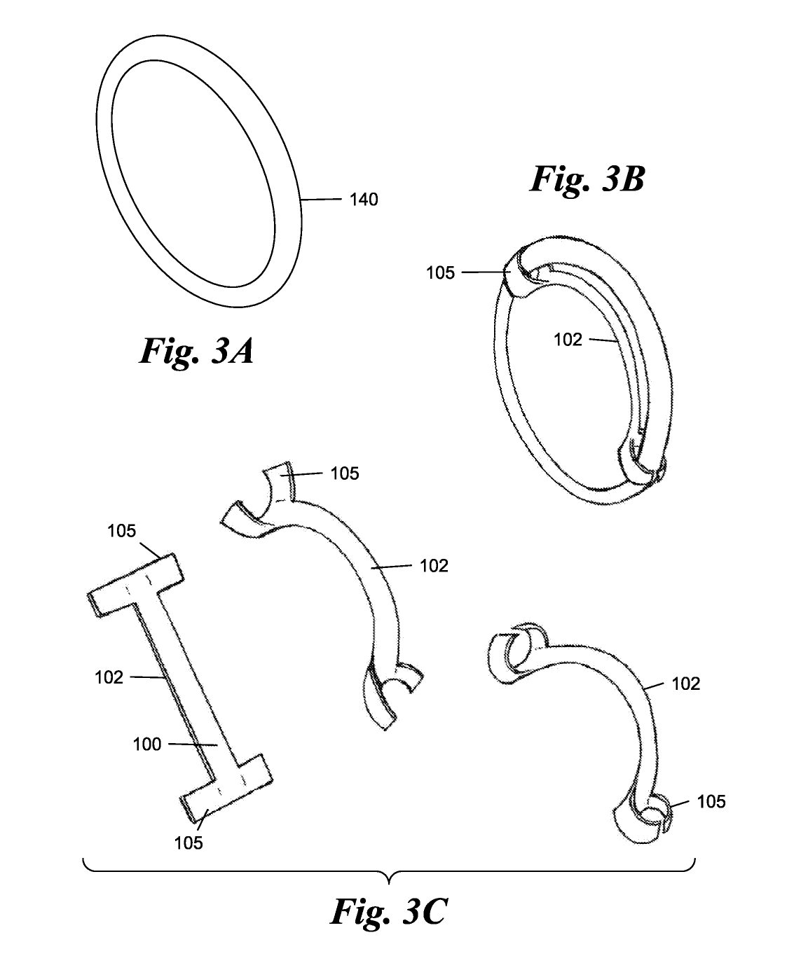

As shown in FIGS. 3A through 3C, a scissor sizer 100 may include a sizer elongated portion 102 and tabs 105 at opposing ends of the elongated portion 102. The tabs 105 may be bendable to fit around and grasp the ring 140 or handle 130 to hold the sizer in place. A sizer may be used to reduce the opening of a ring or handle or similar opening, and a reference to one such structure includes similar structures. When fitted into a ring 140 or handle 130, the sizer 100 reduces the size of the opening of the ring 140 or handle 130. As shown in FIG. 1, in use, the sizer 100 reduces the size of the opening of the handle 130 such that fingers of the user contact the elongated portion 102 of the sizer 100.

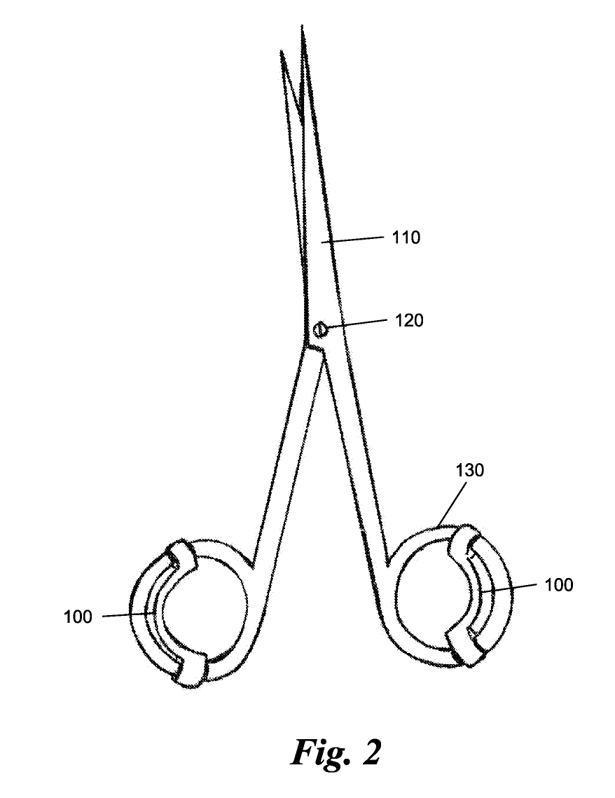

As shown in FIG. 2, scissor sizers 100 may be inserted in the interior portion of a handle 130 in order to reduce the size of the handle opening. The sizer 100 may be of a pre-determined size so as to reduce the size of the opening of scissor handles when the sizer is installed. However, the sizer 100 may be malleable so as to conform to the shape of the scissor handle opening to provide a more secure fit of the sizer with the handle. Further, as the sizer 100 may be malleable, a single sizer 100 may be bent to increase or decrease the size of a particular handle opening. For instance, a sizer may be fitted to a handle so as to be securely fitted against the interior portion of each handle. The sizer may also be fitted, as shown in FIG. 2, such that the elongated portion 102 is positioned at some distance from the interior portion of the handle 130, closer to the center of the handle opening. In this manner, a single sizer may be used to adjust the size of the handle opening depending on the needs, and finger sizes, of each individual user. Various lengths of the sizer 100 further may ensure that the sizers may fit into any size scissor handle opening, for example, from shears to small surgical instruments.

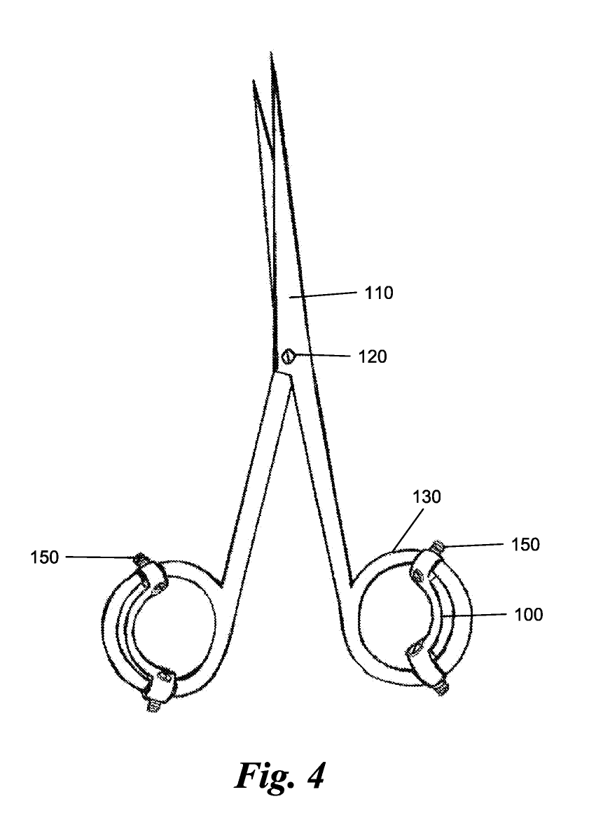

As shown in FIG. 4, each scissor sizer 100 may be secured to the handles by means of attachment screws 150. The attachment screws 150 may be used in conjunction with the tabs 105 as means of attaching the sizers or may be used as a sole means of attachment. The attachment screws 150 may be passed directly through the sizer 100 and into the handle 130 in order to secure the sizer to the handle. In an alternate embodiment, attachment screws 150 may be passed through the bendable tabs 105 in order to further secure the tabs to the handle.

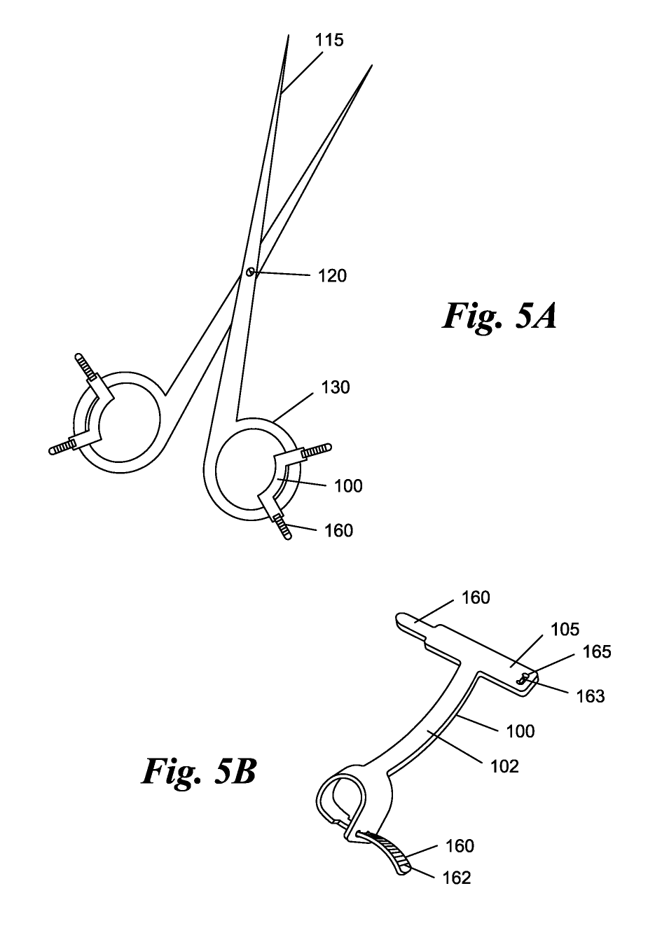

As shown in FIGS. 5A and 5B, the sizer 100 may be secured to the handle 130 by means of a ratchet mechanism. The ratchet mechanism may contain a ratchet tab 160 which may contain high points, or ridges 162, along one side of the ratchet tab 160. The bendable tab 105 and ratchet tab 160 may be fitted to wrap around a scissor handle 130 to secure the sizer 100 to the handle, and the ratchet tab 105 may be fitted into a ratchet slot 165. To secure the ratchet tab 105 within the ratchet slot 165 and aid in securing the entire sizer 100 to the handle 130, the ratchet slot may also contain a ratchet catch 163 consisting of a protruding portion of material which may engage the ridges 162 on the ratchet tab 105 and hold the ratchet tab in place. Force may be applied to direct the ratchet tab 160 further into the ratchet slot 165 to obtain a more secure fit of the sizer 100 to the handle 130. The ratchet mechanism may be constructed of any material but preferably the ratchet mechanism will be constructed of a plastic material or a malleable metal to allow the ratchet tab 160 and bendable tab 105 to be easily wrapped around a handle 130 and the ratchet tab 160 easily inserted through the slot 165.

Further, if scissors are to be utilized primarily by a single individual, the sizer may be permanently affixed, by glue or some other adhesive substance or means of permanent attachment, to the handle opening. Other means of attachment may be used to secure the sizer to the scissor handle opening.

A scissor sizer 100 may be smooth on its inner surface. Alternately, in a preferred embodiment, the sizer may be roughened on the inner surface of the elongated portion 102 so as to enable the sizer to become better secured against the fingers of a user and reduce the amount of slippage against the fingers of a user. A roughened surfaced may be achieved by scoring the surface to create score marks. Use of a roughened surface on the inner surface of the sizer against the fingers of a user will assist in preventing the scissors from slipping from the hands of the user.

In a preferred embodiment, scissor sizers 100 may be constructed of an inexpensive material such as a lightweight metal in order to provide a quickly obtainable and affordable means of adjustment of handle openings. However, the sizers may be constructed of stronger materials at a higher cost, such as stainless steel, depending on the needs and preferences of the user. As sizers may be malleable so that a single sizer may be used to adjust the size of a handle opening to any size, and as there may be variations in the size of the sizers, the invention provides a cost effective means of adjusting the size of finger openings on scissors made by numerous and various manufacturers. Preferably, the scissor sizers are capable of attaching to and fitting any scissor handle openings.

While certain novel features of this invention have been shown and described and are pointed out in the annexed claims, it is not intended to be limited to the details above, since it will be understood that various omissions, modifications, substitutions and changes in the forms and details of the device illustrated and its operation can be made by those skilled in the art without departing in any way from the spirit of the present invention. It will be further understood that each of the elements described above, or two or more together, may also find useful application of other types or methods differing from the types described above. It should be further understood that no limitation of the scope of the invention is thereby intended, such as alterations and further modifications to the illustrated device, and such further applications of the principles of the invention as illustrated herein being contemplated as would normally occur to one skilled in the art to which the invention relates.

I claim:

1. A scissor sizer capable of being fitted and secured to the interior surface of a handle of a pair of scissors, the handle defining an interior area space, the sizer comprising an elongated portion having a first end and a second end, each end containing at least one means of attaching the sizer to the handle, whereby the interior area space of the handle is reduced to permit users with smaller hands to comfortably hold the pair of scissors and accurately utilize the scissors.

2. A scissor sizer as in claim 1 wherein the means of attaching the sizer to the handle comprises at least one bendable tab capable of being bent around the handle to secure the sizer to the handle.

3. A scissor sizer as in claim 1 wherein the means of attaching the sizer comprises at least one screw passed through the sizer and into the handle to secure the sizer to the handle.

4. A scissor sizer as in claim 1 wherein the means of attaching the sizer comprises two bendable tabs capable of being bent around the handle and at least one screw passed through the bendable tabs to secure the sizer to the handle.

5. A scissor sizer as in claim 1 wherein the means of attaching the sizer to the handle comprises at least two bendable tabs capable of being bent around the handle to secure the sizer to the handle and a ratchet mechanism, the ratchet mechanism comprising at least one ratchet tab containing ridges extending from a first bendable tab and a ratchet slot within a second bendable tab for receiving the ratchet tab, the ratchet slot containing a catch for engaging the ridges on the ratchet tab to secure the ratchet tab within the slot.

6. A scissor sizer as in claim 1 wherein the sizer is malleable to permit adjustment of the interior space of the handle.

7. A scissor sizer as in claim 1 wherein the elongated portion has an interior side and an exterior side, the interior side containing a roughened surface enabling the sizer to remain secure and not slip against the hands of a user.

8. A scissor sizer capable of being fitted and secured to the interior surface of a handle of a pair of scissors, the handle defining an interior area space, the sizer comprising an elongated portion having a first end and a second end, the sizer being secured to the handle with an adhesive substance, whereby the interior area space of the handle is reduced to permit users with smaller hands to comfortably hold the pair of scissors and accurately utilize the scissors.

9. A scissor sizer capable of being fitted and secured to the interior surface of a handle of a pair of scissors, the handle defining an interior area space and the sizer comprising an elongated portion having a first end and a second end, the sizer being secured to the handle with a means of permanent attachment, whereby the interior area space of the handle is reduced to permit users with smaller hands to comfortably hold the pair of scissors and accurately utilize the scissors.
